(19) United States
(12) Patent Application Publication
(10) Pub. No.: US 2024/0181413 A1
(43) Pub. Date: Jun. 6, 2024

(54) HEATING ASSEMBLY

(71) Applicant: Honeywell International Inc., Charlotte, NC (US)

(72) Inventors: Mehrad Mehr, Morristown, NJ (US); Bahram Jadidian, Watchung, NJ (US)

(21) Appl. No.: 18/060,887

(22) Filed: Dec. 1, 2022

(51) Int. Cl. B01J 6/00; B01J 19/00; H05B 3/14

(52) U.S. Cl. CPC B01J 6/008; B01J 19/0013; H05B 3/141; B01J 2219/00076; H05B 2203/016; H05B 2203/022; H05B 2214/03

(57) ABSTRACT

In some examples, a heating assembly includes one or more heating rods, a first bus bar, and a second bus bar. Each heating rod of the one or more heating rods defines a first end and a second end, and includes a composite that includes a silicon carbide (SiC) matrix. The first bus bar is coupled to the first end of at least one heating rod and the second bus bar is coupled to the second end of the at least one heating rod.

### GOVERNMENT RIGHTS

This invention was made with Government support under Grant Contract Number 80MSFC21CA010 awarded by NASA. The Government has certain rights in the invention.

### TECHNICAL FIELD

The present disclosure relates to systems and techniques for heating.

### BACKGROUND

Various thermal process systems, such as reactors and heat treatment vessels, may generate heat in a heating assembly and transfer heat from the heating assembly to a process gas or a substrate in the thermal process system. Some thermal process systems operate at relatively high temperatures, and the heating assembly may operate at even higher temperatures to produce an adequate temperature difference for quickly heating a process gas or substrate. For example, methane pyrolysis occurs at a relatively high temperature, and methane pyrolysis reactors may use large amounts of power to heat the methane to a pyrolysis temperature. These high temperatures may limit an effective life of the heating assembly, resulting in frequent replacement, and the corresponding downtime, of the thermal process system. In resource-limited environments, such replacement may require storage of a large number of components.

### SUMMARY

In general, the disclosure describes heating assemblies, including methods of assembly and operation, that include one or more high temperature heating rods configured to efficiently heat a thermal process system. Each heating rod is mechanically robust and is formed from a composite that includes a silicon carbide matrix that generates heat in response to an applied electrical energy. The silicon carbide matrix has a relatively low electrical conductivity that may be further tailored through the use of conductive particles, such that the applied electrical energy may have a relatively high voltage and a relatively low current.

In some examples, the heating rods are configured to be modularly assembled using conductive bus bars into a variety of spatial and/or electrical configurations, including parallel, series, and combinations thereof, that produce a particular spatial heating profile for heating a substrate or vessel containing a process gas. This modular assembly may enable simple and discrete replacement of a single heating rod to reduce a weight and/or maintenance load in resource- or mobility-limited environments. The heating rods may include threads that function as connective guides for coupling to bus bars and/or attaching bridging structures, such as graphite nuts, to electrically bridge discontinuities, such as cracks, that may form in the heating rods. In these various ways, heating assemblies described herein may be efficient, repairable, and particularly suited to thermal processes systems in resource limited environments.

In some examples, the disclosure describes a heating assembly that includes one or more heating rods, a first bus bar, and a second bus bar. Each heating rod of the one or more heating rods define a first end and a second end, and includes a composite that includes a silicon carbide (SiC) matrix. The first bus bar is coupled to the first end of at least one heating rod and the second bus bar is coupled to the second end of the at least one heating rod.

In some examples, the disclosure describes a heating assembly package that includes one or more heating rods and a set of bus bars. The one or more heating rods include a composite that includes a silicon carbide (SiC) matrix. The set of bus bars is configured to electrically couple the one or more heating rods to a power circuit to deliver electrical energy to the one or more heating rods.

In some examples, the disclosure describes a thermal process system that includes a vessel configured to house one or more process gases and a heating assembly configured to heat the vessel. The heating assembly includes one or more heating rods, a first bus bar, and a second bus bar. Each heating rod of the one or more heating rods defines a first end and a second end, and includes a composite that includes a silicon carbide (SiC) matrix. The first bus bar is coupled to the first end of at least one heating rod and the second bus bar is coupled to the second end of the at least one heating rod.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a cross-sectional side view diagram illustrating an example thermal process system for pyrolyzing hydrocarbons.

FIG. 1B is a perspective view diagram illustrating the example thermal process system of FIG. 1A in partial disassembly.

FIG. 1C is a perspective view diagram illustrating an example heating rod of a heating assembly of a thermal process system.

FIG. 1D is a perspective view diagram illustrating an example conductive sleeve for use with the example heating rod of FIG. 1C.

FIG. 1E is a perspective view diagram illustrating an example inter-rod bus bar of a heating assembly of a thermal process system.

FIG. 1F is a perspective view diagram illustrating an example end bus bar of a heating assembly of a thermal process system.

FIG. 1G is a perspective view diagram illustrating an example end inter-rod bus bar of a heating assembly of a thermal process system.

FIG. 1H is a block diagram illustrating an example thermal process system that includes a power circuit.

FIG. 2A is a side view diagram illustrating an example series configuration of heating rods in a heating assembly.

FIG. 2B is a side view diagram illustrating an example parallel configuration of heating rods in a heating assembly.

FIG. 2C is a side view diagram illustrating an example mixed configuration of heating rods in a heating assembly.

FIG. 3A is a flowchart of an example technique for replacing a heating rod of a heating assembly.

FIG. 3B is a flowchart of an example technique for repairing a heating rod of a heating assembly.

FIG. 3C is a flowchart of an example technique for forming a heating rod of a heating assembly.

### DETAILED DESCRIPTION

In general, the disclosure describes heating assemblies, including methods of assembly and operation, that include one or more relatively high temperature (e.g., greater than about 850° C.) heating rods configured to efficiently heat a thermal process system.

Thermal process systems, such as systems for pyrolyzing hydrocarbons, may include heating assemblies that generate heat to maintain a substrate or process gas at a high temperature, such as for reactions or heat treatments. For example, a hydrocarbon pyrolysis reactor may heat hydrocarbons to pyrolyze the hydrocarbons. To generate heat, heating elements of the heating assemblies may be subject to at least the high temperature of the substrate or process gases, and may undergo thermal cycling between high temperatures during operation and low temperatures outside of operation. As a result of these high and/or variable temperatures, the heating elements may experience oxidation or thermal stresses that form cracks or other damage in the heating elements.

In a resource-limited environment, such as an aircraft, spacecraft, or submerged watercraft, long service life of heating elements may be particularly important, as replacement heating elements may take up space and require difficult repairs. Resistive heating elements that generate heat in response to an electrical energy may be particularly robust and suited to thermal process systems in resource-limited environments. For example, resistive heating elements may include conductive materials, such as ceramics or metals, that have high mechanical strength and are capable of generating heat through a Joule heating effect. However, resistive heating elements may use large amounts of power and operate under high current, such that components of a power circuit for powering the resistive heating elements may operate with reduced efficiency compared to components of a power circuit that provide lower current electrical energy. Further, resistive heating elements may be dependent on electrical continuity of the heating element, such that a crack or other discontinuity may substantially reduce end-to-end electrical conductivity, and may require replacement of the entire heating assembly.

According to various examples described herein, heating assemblies include one or more high temperature heating rods that are configured to efficiently provide heat to a thermal process system. Each heating rod is formed from a mechanically robust composite that is thermally stable at relatively high temperatures, such as greater than about 850° C., and relatively inert in the presence of process gases, such as hydrocarbons. The composite includes a ceramic reinforcement material that provides mechanical strength to the composite and a silicon carbide matrix that generates heat in response to applied electrical energy. The silicon carbide matrix has a relatively low electrical conductivity, and is capable of generating heat from applied electrical energy having a relatively high voltage and a relatively low current (or a relatively high current and relatively low voltage) compared to materials used in resistive heating elements that have a higher electrical conductivity. The electrical conductivity of the silicon carbide matrix may be tailored from a baseline electrical conductivity of silicon carbide by including conductive particles, such as silicon nitride particles, in a silicon carbide slurry during infiltration of a preform of the ceramic reinforcement material.

Heating assemblies described herein may be modularly assembled using a set of conductive bus bars that couple to one or more heating rods and provide a variety of different spatial arrangements and electrical configurations of the heating rods. As one example, the bus bars may accommodate various spatial connections of heating rods such that the heating rods may be oriented to generate a particular heating profile tailored to a shape of a substrate or thermal process vessel. As another example, the bus bars may accommodate various electrical connections of heating rods such that the heating rods may operate according to particular electrical properties (e.g., voltage) of the applied electrical energy, such as parallel connections, series connections, or a combination of parallel and series connections.

Heating assemblies described herein may enable simple and discrete replacement and/or repair of a single heating rod to reduce a weight and/or maintenance load, which may be particularly important in resource- or mobility-limited environments. The heating rods may include threads that function as connective guides for interfacing with threads in the bus bars. To replace a damaged heating rod, the damaged heating rod may be detached from the bus bars and replaced with a new heating rod, such as by rotating nuts of the bus bars. Additionally or alternatively, the threads may function as connective guides for attaching electrical bridging structures, such as graphite nuts, for electrically bridging discontinuities, such as cracks, that may form in the ceramic heating rods. To repair a damaged heating rod, an end of the heating rod may be detached from a bus bar, a conductive sleeve or other electrical bridging structure may be threaded onto the heating rod across the location of the discontinuity, and the heating rod reattached to the bus bar.

In these various ways, heating assemblies described herein may be efficient, repairable, and particularly suited to thermal processes systems in resource limited environments.

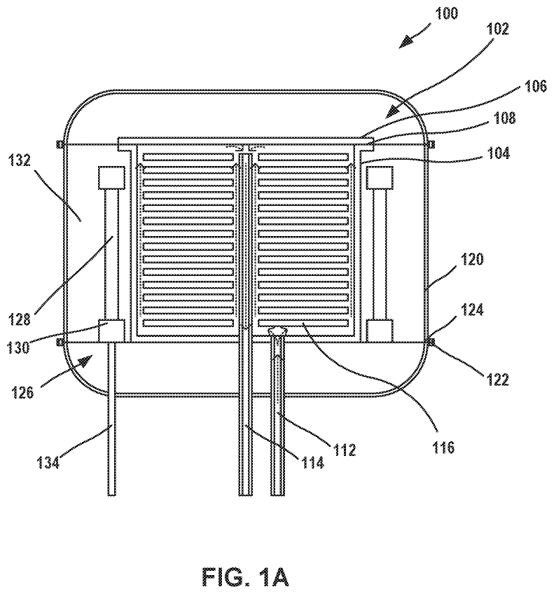

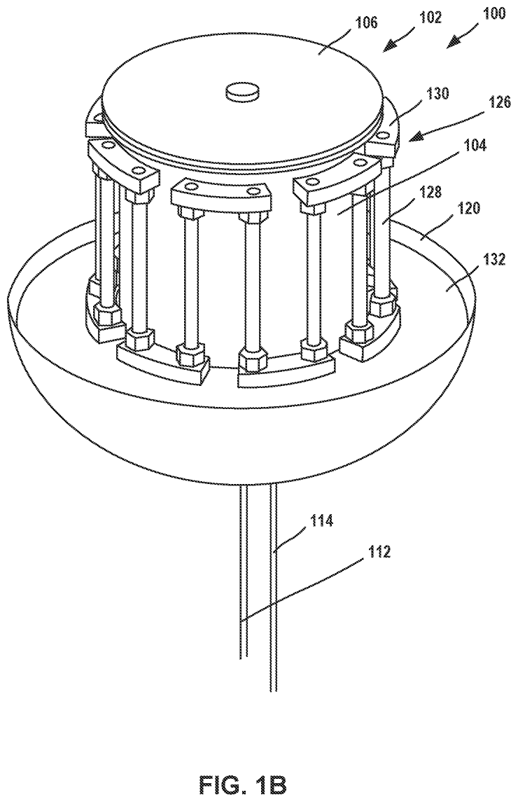

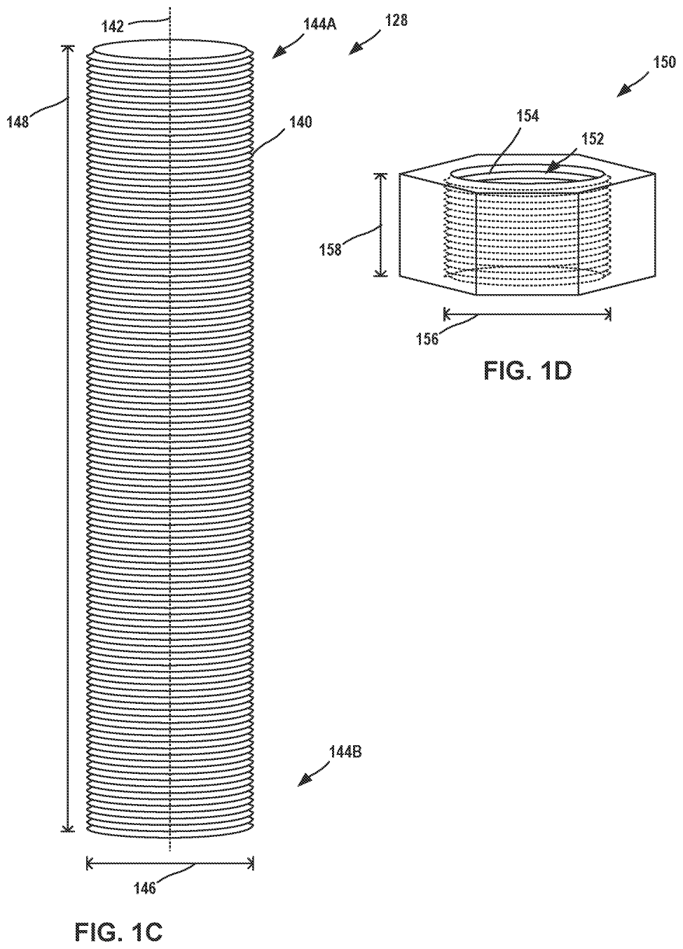

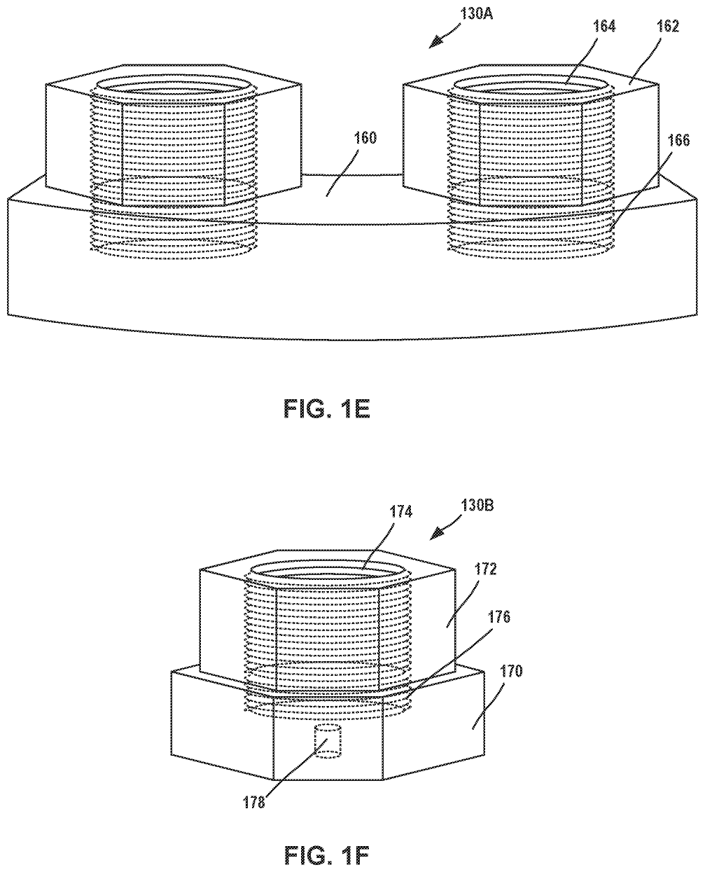

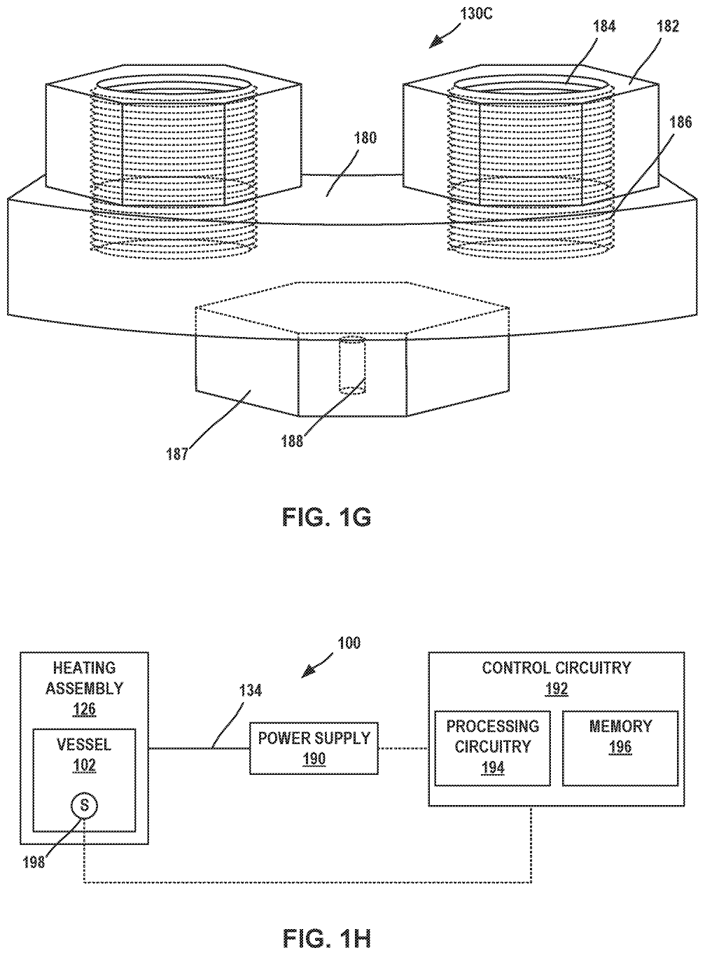

Heating assemblies described herein may be used in a variety of thermal process systems, such as methane pyrolysis reactors, that operate at high temperatures and/or experience high (e.g., frequent or high variation) thermal cycling loads. In some examples, thermal process systems described herein may be utilized in aerospace applications, such as spacecraft. For example, a spacecraft may include a resource-limited and weight- and volume-sensitive environment for which resources like oxygen and water may be preserved in closed loop processes. The thermal process systems described herein may be used for various high temperature processes intended to preserve resources within this environment, such as a pyrolysis reactor for methane pyrolysis. FIG. 1A is a cross-sectional side view diagram illustrating an example thermal process system 100, such as a pyrolysis reactor for generating hydrogen gas from hydrocarbons. However, in other examples, thermal process system 100 may be used for reactions or heat treatments other than methane pyrolysis that proceed at high temperatures.

Thermal process system 100 includes a vessel 102. In the example of FIG. 1A, vessel 102 is a retort assembly that includes a vessel chamber 104 and a removable vessel lid 106; however, in other examples, vessel 102 has other forms and configurations, such as a vessel having a monolithic containment boundary. Vessel 102 is configured to substantially contain one or more process gases in vessel chamber 104 during a thermal process. For example, vessel chamber 104 and vessel lid 106 may define a process volume in which one or more process gases undergo a reaction or heat process.

Vessel 102 may have any of a variety of shapes, including relatively unconventional shapes for which customized thermal management devices may be used. In the example of FIG. 1A, vessel 102 may be configured for general flow along an axis of vessel chamber 104, such that process gases, such as hydrocarbon gases, may be continuously received and product gases, such as hydrogen gas, reaction byproducts, and unreacted hydrocarbon gases, may be continuously discharged from thermal process system 100. Vessel 102 is configured to form a containment boundary for the one or more process gases in vessel chamber 104. Once positioned, vessel chamber 104 and vessel lid 106 may be configured to contain the one or more process gases and substantially prevent the process gases from migrating from the vessel volume into another volume, or other gases from migrating into the vessel volume.

Thermal process system 100 includes one or more process gas inlets 112 configured to discharge an inlet gas mixture into vessel chamber 104 and one or more gas outlets 114 configured to receive an outlet gas mixture from vessel chamber 104. In the example of FIG. 1A, inlet 112 includes an opening at a first end of vessel chamber 104 for discharging the inlet gas mixture into vessel chamber 104, while outlet 114 includes an opening at a second, opposite end for receiving gases from vessel chamber 104. As a result, gases may flow from process gas inlet 112 through the vessel volume within vessel chamber 104, including a substrate 116, and to gas outlet 114.

During a thermal process, such as a reaction, heating process, or inerting process, the process volume within vessel chamber 104 may be at relatively high temperatures. For example, for methane pyrolysis, process gases within the process volume may have a temperature greater than about 850° C. As such, vessel 102 may be configured for exposure to relatively high temperatures. In some examples, each of vessel lid 106 and vessel chamber 104 includes non-metallic materials, such as graphite, a ceramic, or a ceramic matrix composite. Non-metallic materials may be stronger and more resistant to creep, corrosion, instabilities, or other high temperature structural defects than metals. Provided acceptable high-temperature strength and toughness, the properties of interest for materials of vessel 102 may include, but are not limited to: reduced density, such as to reduce weight; increased chemical compatibility with gases, such as methane and hydrogen, at high temperatures; thermal stability; thermal conductivity; hardness, such as to increase robustness and/or dimensional stability; manufacturability; and the like.

In some examples, such as the example of FIG. 1A, thermal process system 100 includes an additional vessel housing 120 positioned around vessel 102 and one or more heating rods 128. Vessel housing 120 is configured to maintain a pressure within vessel 102 by forming a pressure boundary for one or more gases in vessel 102. Materials used for vessel housing 120 may be selected for relatively low weight, such as aluminum. In some examples, vessel housing 120 may be configured in two or more sections to at least partially disassemble to access one or more components within vessel housing 120. In the example of FIG. 1A, vessel housing 120 includes a top end cap, a body, and a bottom end cap. Adjacent sections of vessel housing 120 may be attached using one or more connectors 122 and hermetically sealed against each other using one or more seals 124 positioned at an interface between adjacent sections of vessel housing 120. For example, connectors 122 may include bolts or other fasteners, and seals 124 may include one or more O-rings.

Thermal process system 100 may include various thermal retention materials surrounding vessel chamber 104 and/or vessel lid 106 and configured to retain heat within vessel chamber 104. In some examples, thermal process system 100 may include insulation materials configured to reduce thermal conductive losses from vessel chamber 104. In the example of FIG. 1A, thermal process system 100 includes insulation 132 surrounding vessel chamber 104 and one or more heating rods 128 of a heating assembly 126. In some examples, insulation 132 includes solid insulation material, such as a solid microporous ceramic insulation material capable of working temperatures up to about 1200° C.

Thermal process system 100 includes a heating assembly 126 configured to heat vessel 102 and, correspondingly, heat one or more process gases within vessel 102. Heating assembly 126 includes one or more heating rods 128 and one or more bus bars 130 positioned around vessel chamber 104. In some examples, electrical connectors 134 for heating assembly 126 are positioned opposite vessel lid 106 or through other interfaces that may not interfere with removal of lid 106 from vessel chamber 104. Electrical connectors 134 may be configured to electrically couple to a power source, such as an alternating current (AC) or direct current (DC) power source. Heating assembly 126 will be described further in FIG. 1B below.

While thermal process system 100 of FIG. 1A has been described with respect to vessel 102 surrounded by insulation 132 and vessel housing 120, in other examples, a thermal process system used with heating assemblies described herein may include a single vessel for which heating assembly 126 is in direct or indirect thermal contact with a process gas or substrate. For example, vessel 102 may be a hot-wall reactor or include heating assembly 126 as an internal system.

FIG. 1B is a perspective view diagram illustrating the example thermal process system 100 of FIG. 1A in partial disassembly and including heating assembly 126. Heating assembly 126 may be spatially configured (e.g., arranged and positioned) such that heating rods 128 deliver heat to an adjacent object or volume. In the example of FIG. 1B, heating rods 128 deliver heat to a wall of vessel chamber 104, such that heating assembly 126 is configured in a circular arrangement around vessel 102 to heat vessel 102. However, in other examples, heating assembly 126 may be spatially configured to heat other volumes or objects, such as a heating assembly that includes heating rods in a linear arrangement to heat a planar surface of a substrate.

Heating assembly 126 includes one or more heating rods 128. Each heating rod 128 is configured to receive applied electrical energy and generate heat in response to the applied electrical energy. In the example of FIG. 1B, heating assembly 126 is configured to generate heat in a bulk of heating rods 128 and transfer the heat from a surface of heating rods 128 to heat a wall of vessel 102 and, correspondingly, a process gas within vessel 102. The heat generated by heating rods 128 may be transferred to a substrate or object using any suitable heating mechanism including conductive heat transfer, convective heat transfer, or radiative heat transfer.

Each heating rod 128 is configured to electrically and mechanically couple to two or more bus bars 130. Correspondingly, each bus bar 130 is configured to couple to an end of at least one heating rod 128 and transfer electrical energy to or from heating rod 128. In addition to coupling to an end of a heating rod 128, each bus bar 130 is configured to couple to either an electrical connector (e.g., electrical connector 134, not shown in FIG. 1B) or another heating rod 128.

In operation, to heat vessel 102, control circuitry (e.g., shown in FIG. 1H) may control a power source (e.g., shown in FIG. 1H) to deliver an electrical energy to heating assembly 126. Heating assembly 126 may receive the electrical energy, such as through one or more bus bars 130 electrically coupled to electrical connector 134 of FIG. 1A. The electrical energy may have particular electrical properties, such as voltage and current, that cause the heating rods 128 to generate a particular amount of heat. The generated heat may transfer from heating rods 128 to a wall of vessel 102 to heat one or more process gases in vessel 102. The various parameters of the electrical energy may be configured to cause heating rods 128 to generate heat sufficient to heat the process gases in vessel 102 to a particular temperature, such as a reaction or heat treatment temperature.

FIG. 1C is a perspective view diagram illustrating an example heating rod 128 of a heating assembly of a thermal process system, such as heating assembly 126 of thermal process system 100 of FIGS. 1A and 1B. Heating rod 128 defines a first end 144A and a second, opposite end 144B (generically and collectively, “ends 144” or “ends 144”). In some examples, each end 144 is configured to mechanically and electrically couple to a bus bar, such as bus bar 130 of FIGS. 1B and 1E-1G described below.

Heating rod 128 is formed from a composite configured to generate heat in response to application of electrical energy to heating rod 128. The composite of heating rod 128 includes a ceramic reinforcement material in a silicon carbide (SiC) matrix. A variety of ceramic reinforcement materials may be used including, but not limited to, SiC, silicon nitride, carbon, or any other ceramic material. In some examples, heating rod 128 includes a SiC/SiC ceramic composite having a SiC reinforcement material. The composite may be relatively robust, such that heating rods 128 may accommodate high temperatures and thermal stresses resulting from thermal cycling for a long period of time without cracking.

Heating rod 128 has a diameter 146 representing a maximum dimension of heating rod 128 across an axis 142 of heating rod 128 and a length 148 representing a maximum dimension of heating rod 128 along axis 142 of heating rod 128. Heating rod 128 may have a substantially elongated shape, such that length 148 of heating rod 128 is substantially greater than diameter 146 of heating rod 128. For example, length 148 of heating rod 128 may be at least ten times greater than diameter 146 of heating rod 128. Diameter 146 may be selected for a variety of factors including mechanical strength, heat dispersal, conductive cross-sectional area, or other factors related to mechanical strength or heat generation or distribution of heating rod 128. For example, as diameter 146 increases, a mechanical strength of heating rod 128 may increase, a cross sectional area of heating rod 128 may increase, and an amount of heat transfer for a particular volume of heating rod 128 may decrease. In other examples, heating rod 128 may not be cylindrical in shape, e.g., may not define a diameter 146, in which case the discussion of diameter 146 herein may refer to a greatest cross-sectional dimension, the cross-section being taken orthogonal to axis 142.

As mentioned above, heating rod 128 is formed from a composite that includes a silicon carbide matrix. Silicon carbide has a relatively low electrical conductivity, such as an electrical conductivity less than about 10⁵ siemens per meter (S/m). In some examples, the electrical conductivity of silicon carbide may be configured based on a microstructure of the silicon carbide, such as a degree or type of crystallinity of the silicon carbide. For example, crystalline silicon carbide may have a higher electrical conductivity than amorphous silicon carbide. In some examples, the electrical conductivity of the silicon carbide matrix may be configured based on a stoichiometric ratio of silicon to carbon. For example, silicon carbide having a stoichiometric excess of silicon may have a higher electrical conductivity than silicon carbide having a stoichiometric excess of carbon.

In some examples, the composite includes one or more conductive materials (e.g., referred to as conductive fillers) in the silicon carbide matrix configured to increase the electrical conductivity of the composite beyond a baseline electrical conductivity of silicon carbide. As one example, an overall resistance of heating rod 128 may be tailored for electrical characteristics of a particular power source. As another example, an overall resistance of heating rod 128 may be tailored using the conductive fillers such that heating rod 128 having a particular set of dimensions may have a particular electrical conductivity. Heating rod 128 may have a set of dimensions that are configured to provide sufficient mechanical strength to heating rod 128. However, the set of dimensions may also affect an overall resistance of heating rod 128. For example, heating rod 128 made from a silicon carbide matrix may have sufficient thickness for mechanical strength, but may have an overall resistance that is too high for the particular application (e.g., heating profile or available power source). To maintain adequate mechanical strength, while providing a desired overall resistance for a particular heating profile or power source, conductive fillers may be incorporated into the silicon carbide matrix to produce a particular electrical conductivity of the composite.

Conductive fillers, such as conductive particles or whiskers, may be distributed in the silicon carbide matrix during formation of the silicon carbide matrix. The resulting electrical conductivity may be higher than an electrical conductivity of silicon carbide, but lower than an electrical conductivity of metals or other ceramics. For example, the electrical conductivity of the composite including one or more conductive fillers in a silicon carbide matrix may be less than about 10⁸ siemens per meter (S/m), but greater than about 10⁵ S/m. In some examples, a concentration of the one or more fillers is less than about 50 weight percent (wt. %) of the composite. A variety of materials may be used as conductive fillers including, but not limited to, metals, such as aluminum; ceramics, such as graphite, silicon nitride, or silicon carbide; and the like.

In some examples, such as illustrated in FIG. 1C, heating rod 128 is fully or partially threaded. For example, heating rods 128 may include threads 140 along an axis of heating rod 128, such as along axis 142 in the example of FIG. 1C. Threads 140 may have any of a variety of thread counts suitable for interfacing with bus bars 130 and/or additional structures. Threads 140 may function as supportive structures for coupling heating rod 128 to bus bars 130 and/or attaching additional structures. In some examples, threads 140 at ends 144 may be configured to interface with threads of a bus bar to electrically and mechanically couple to the bus bar.

In some examples, threads 140 are configured to accommodate a repair structure, such as a conductive sleeve, configured to increase electrical connectivity across a discontinuity between ends 144 of heating rod 128. FIG. 1D is a perspective view diagram illustrating an example conductive sleeve 150 for use with the example heating rod 128 of FIG. 1C. Conductive sleeve 150 defines a lumen 152 that includes threads 154 and has a diameter 156. Threads 154 of conductive sleeve 150 may be configured to interface with threads 140 of heating rod 128. Conductive sleeve 150 may be configured to thread onto heating rod 128 and bridge a flow of electrical energy across a crack or other discontinuity in heating rod 128.

While illustrated as interfacing with heating rod 128 with threads, in other examples, conductive sleeve 150 may be configured to electrically bridge a discontinuity using any interfacing mechanism that includes electrically contacting heating rod 128 across a discontinuity, such as an interference fit mechanism. Conductive sleeve 150 may have a length 158 sufficient to bridge the discontinuity without substantially increasing or decreasing an end-to-end electrical conductivity of heating rod 128 prior to the discontinuity being formed. For example, length 158 may be selected such that an overall electrical conductivity of a heating rod that is repaired by conductive sleeve 150 may be within 1% to 10% of an electrical conductivity of the heating rod prior to the discontinuity.

Conductive sleeve 150 includes any one or more of a variety of conductive materials including, but not limited to, metals, conductive ceramics, or other conductive materials having a sufficiently high thermal stability at operating temperatures of heating rod 128. In some examples, conductive sleeve 150 has an electrical conductivity that is within an order of magnitude of an electrical conductivity of the composite of heating rod 128, such that an end-to-end electrical conductivity of heating rod 128 may remain relatively unchanged after positioning of conductive sleeve 150 across the discontinuity. In some examples, conductive sleeve 150 includes a material having an electrical conductivity greater than the composite of heating rod 128, such as greater than about 10⁶ siemens per meter (S/m), such that conductive sleeve 150 may moderate an increased length of a conductive path of electrical energy through heating rod 128. In some examples, conductive sleeve 150 includes graphite, which may have a closer electrical conductivity and coefficient of thermal expansion to silicon carbide than metals while having a sufficiently high thermal stability at operating temperatures of heating rod 128.

In addition to electrical properties, conductive sleeve 150 may include a material selected for thermal and/or mechanical properties. In some examples, conductive sleeve 150 has a coefficient of thermal expansion that is substantially similar to a coefficient of thermal expansion (CTE) of the composite of heating rod 128, such as within about 5 ppm/° C. For example, when heating rod 128 and conductive sleeve 150 heat up, relative expansion of heating rod 128 and conductive sleeve 150 along an axis of heating rod 128 may generate thermal stresses. By reducing a different in CTEs in the material of conductive sleeve 150 and the composite of heating rod 128, such thermal stresses may be reduced. In some examples, conductive sleeve 150 may be configured to mechanically bridge a discontinuity in heating rod 128. For example, conductive sleeve 150 may include a material having a relatively high tensile strength to hold heating rod 128 together across a discontinuity, such that a length of heating rod 128 may not substantially change despite the discontinuity in heating rod 128.

FIGS. 1E-1G illustrate various examples of bus bars 130A, 130B, 130C (collectively “bus bars 130”) configured to mechanically and electrically couple heating rods 128 together and/or electrically couple heating rods 128 to a power circuit to form heating assembly 126. While mechanical and electrical connectivity will be described according to particular mechanisms, such as rotating nuts for mechanically coupling heating rods 128, other mechanisms may be used to achieve the function of electrical and mechanical connectivity. For example, in the example bus bars 130 of FIGS. 1E-1G, bus bars 130 are configured to interface with a threaded heating rod, such as heating rod 128 of FIG. 1C, in a manner that permits only partial disassembly of a heating assembly.

Referring collectively to bus bars of FIGS. 1E-1G, in some examples, bus bars 130 include a material having a relatively high electrical conductivity compared to the composite of heating rods 128. For example, bus bars 130 may include a material having an electrical conductivity greater than about 10⁶ siemens per meter (S/m). In some examples, bus bars 130 may include graphite. Graphite may have a sufficiently high electrical conductivity to produce low amounts of heat and may have a relatively low coefficient of thermal expansion compared to metals, thereby reducing thermal stresses on heating rods 128.

In some examples, bus bars 130 of heating system 100 are configured to function as an electrical conduit for connecting heating rods 128 in series. FIG. 1E is a perspective view diagram illustrating an example inter-rod bus bar 130A of a heating assembly of a thermal process system. Inter-rod bus bar 130A may be configured to couple to an end of a first heating rod and an end of a second heating rod. Inter-rod bus bar 130A includes a conduit body 160 that includes threads 166 and two rod nuts 162 that each include threads 164. Conduit body 160 may be configured to receive an end of a threaded heating rod, such as heating rod 128, and interface with threads of heating rod 128 using threads 166. Each rod nut 162 may be configured to rotate relative to conduit body 160 to interface with the end of heating rod 128 and secure heating rod 128 to inter-rod bus bar 130A.

In some examples, one or more bus bars of a heating assembly are configured to function as electrical connectors for connecting heating rods to a power circuit. FIG. 1F is a perspective view diagram illustrating an example end bus bar 130B of a heating assembly of a thermal process system. End bus bar 130B may be configured to electrically couple at least one heating rod to the power circuit (e.g., shown in FIG. 1H). End bus bar 130B includes a connector body 170 that includes threads 176 and one rod nut 172 that includes threads 174. Connector body 170 may be configured to receive an end of a threaded heating rod, such as heating rod 128, and interface with threads of heating rod 128 using threads 176. Rod nut 172 may be configured to rotate relative to connector body 170 to interface with the end of heating rod 128 and secure heating rod 128 to inter-rod bus bar 130B. Connector body 170 includes an electrical plug 176 configured to interface with an electrical connector, such as electrical connector 134 of FIG. 1A, to electrically couple bus bar 130B to a power circuit.

In some examples, bus bars of a heating assembly are configured to function as both electrical conduits and electrical connectors for connecting heating rods in parallel and to a power circuit. FIG. 1G is a perspective view diagram illustrating an example end inter-rod bus bar 130C of a heating assembly of a thermal process system. End inter-rod bus bar 130C may be configured to electrically couple two or more heating rods to the power circuit. End inter-rod bus bar 130C includes a conduit body 180 that includes threads 186, a connector body 187, and two rod nut 182 that each include threads 184. Conduit body 180 may be configured to receive an end of a threaded heating rod, such as heating rod 128, and interface with threads of heating rod 128 using threads 186. Each rod nut 182 may be configured to rotate relative to conduit body 180 to interface with an end of a threaded heating rod, such as heating rod 128, and secure heating rod 128 to end inter-rod bus bar 130C. Connector body 187 includes an electrical plug 188 configured to interface with an electrical connector, such as electrical connector 134 of FIG. 1A, to electrically couple bus bar 130C to a power circuit.

Heating assemblies described herein may be assembled from a heating assembly package that includes one or more heating rods and a set of bus bars configured to electrically couple the one or more heating rods to a power circuit to deliver electrical energy to the one or more heating rods, such as heating rods 128 and bus bars 130. In some heating assembly packages, at least a portion of the one or more heating rods 128 may be configured to be interchangeable, such that a low number of heating rods may be maintained for replacement. For example, heating rods 128 may have a similar composition and set of dimensions (e.g., length 148, diameter 146, and bulk electrical conductivity), such that a replacement heating rod may replace a heating rod in a group of heating rods (e.g., of system 100). Further, in a heating assembly package, a shape of the heating assembly may be configured by selecting particular bus bars of the set of bus bars and orienting the heating rods and bus bars to produce a desired shape of the heating assembly and/or heating profile generated by the heating assembly. For example, the set of bus bars may include bus bars having various sets of dimensions (e.g., length of conduit body, thickness of connector body, and spacing of rod nuts) such that the heating rods may be positioned and arranged in a desired spatial and/or electrical configuration.

In some examples, a heating assembly package includes two or more heating rods 128 and various selections of bus bars 130. For example, to assemble heating assembly 126 illustrated in FIG. 1B, a heating assembly package may include 16 heating rods 128 of FIG. 1C to surround vessel 102, 15 inter-rod bus bars of FIG. 1E to connect the 16 heating rods 128 in series, and 2 connective bus bars of FIG. 1G to electrically couple the 16 heating rods 128 and 15 inter-rod bus bars 130 to a power supply.

In some examples, the heating assembly package includes one or more replacement heating rods 128 or bus bars 130. Continuing with the example above, in the event of one of heating rods 128 or inter-rod bus bars requiring replacement, any one of the 16 heating rods may be replaced with a single type (e.g., size and shape) of heating rod 128, and any one of the 15 inter-rod bus bars may be replaced with a single type of inter-rod bus bar. In this way, a relatively low number of replacement heating rods 128 and/or bus bars 130 may be stocked to maintain operation of heating assembly 126.

In some examples, the heating assembly package includes one or more conductive sleeves 150 configured to thread onto heating rods 128 and bridge a flow of electrical energy across a discontinuity in a heating rod 128. For example, conductive sleeves 150 having various lengths 158 may be included to repair discontinuities having different axial lengths, such that an amount of an electrical path through heating rod 128 that is bypassed may be reduced. In this way, discontinuities in a heating rod that may typically require replacement may instead be repaired by a conductive sleeve 150, and fewer replacement heating rods 128 may be stocked.

Heating assemblies described herein may be controlled by a power circuit. FIG. 1H is a block diagram illustrating an example thermal process system 100 that includes a power circuit, including a power supply 190 and control circuitry 192. While described functionally as discrete units, power supply 190 and control circuitry 192 may be configured in any functional arrangement, including as a single unit or more than two units.

Power supply 190 is configured to supply electrical energy to heating assembly 126 through electrical connector 134. Power supply 190 is communicatively coupled to control circuitry 192 and configured to control electrical parameters of the electrical energy based on control signals from control circuitry 192. For example, power supply 190 may be configured to receive a control signal from control circuitry 192 that indicates a desired power level and/or set of electrical parameters and generate and deliver electrical energy having a particular voltage and/or current (or range of voltages and/or currents) corresponding to a desired power level and/or set of electrical parameters indicated by the control signal.

Control circuitry 192 is configured to control power supply 190 to supply the electrical energy to heating assembly. In the example of FIG. 1H, control circuitry 192 is communicatively coupled to power supply 190 and one or more sensors 198 within vessel 102, such as temperature and/or pressure sensors. Control circuitry 192 may be configured to send control signals to power supply 190 indicating a power level or set of electrical parameters. Control circuitry 192 may be configured to receive measurement signals from sensors 198, such as temperature measurement signals indicating a temperature within vessel 102. For example, control circuitry 192 may be configured to receive a temperature signal that indicates a temperature of one or more process gases within vessel 102 or a substrate exposed to heating assembly 126. In some examples, control circuitry 192 may be configured to control heating assembly 126 based on temperature measurement signals received from sensors 198.

Control circuitry 192 includes processing circuitry 194 and memory 196. Processing circuitry 194 may be configured to execute control algorithms that define a particular heating profile in terms of respective values for electrical parameters delivered by power supply 190 to heating assembly 126, such as duty cycle, current or voltage amplitude, and/or frequency. Processing circuitry 194 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to processing circuitry 194 herein may be embodied as software, firmware, hardware, or any combination thereof. Memory 196 includes computer-readable instructions that, when executed by processing circuitry 194, causes control circuitry 192 to perform various functions, such as control algorithms. Memory 196 may include any volatile, non-volatile, magnetic, optical, or electrical media, such as a random-access memory (RAM), read-only memory (ROM), non-volatile RAM (NVRAM), electrically-erasable programmable ROM (EEPROM), flash memory, or any other digital media.

Power circuits, such as power supply 190 and/or control circuitry 192, coupled to a heating assembly (e.g., of system 100) that includes heating rods having a silicon carbide matrix may be configured to operate more efficiently than power circuits coupled to a heating assembly that includes heating elements made from materials having higher electrical conductivity. For example, power supply 190 may be configured to supply electrical energy having a higher voltage and lower current (or a lower voltage and a higher current) for a particular power level. As a result of this reduced current, power supply 190 and control circuitry 192 may operate more efficiently. In some examples, a lower current may reduce a cross-sectional area of electrical connector 134 and, correspondingly, reduce a gap in insulation for accommodating electrical connector 134.

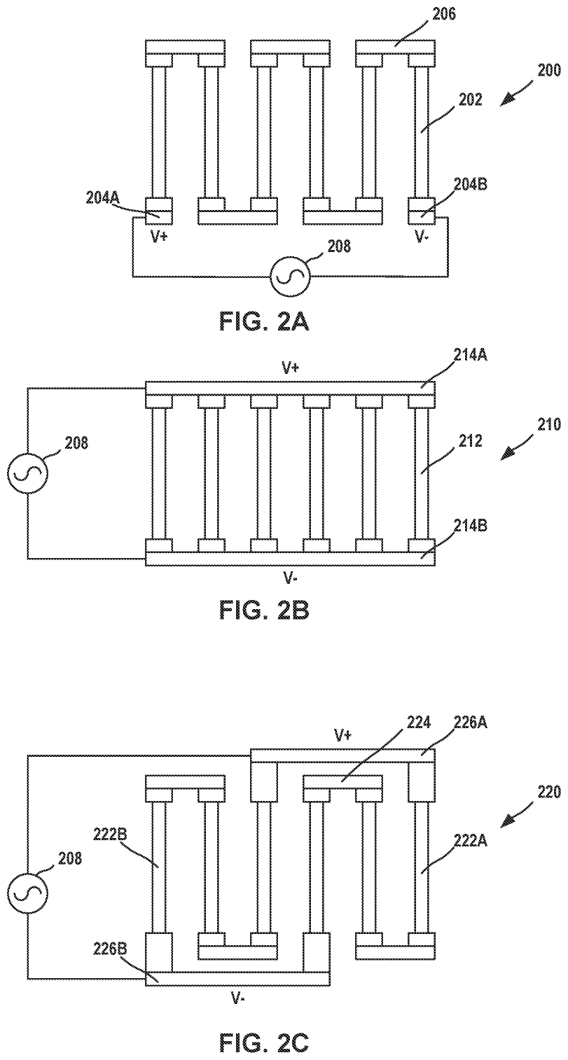

Heating assemblies described herein may be configured in a variety of ways according to a desired voltage, current, and power output. FIGS. 2A-2C illustrate various configurations of six heating rods to receive different amounts of current and at different voltages based on connection and arrangement of a set of bus bars. The heating rods can be heating rods 128 of system 100 (FIG. 1A) or heating rods including SiC of another system.

In some examples, heating assemblies include heating rods connected in series. FIG. 2A is a side view diagram illustrating an example series configuration of heating rods in a heating assembly 200. Heating assembly 200 includes two or more heating rods 202 connected in series by connective bus bars 206 and coupled to a current source at an inlet end bus bar 204A and an outlet end bus bar 204B. Heating assembly 200 may operate at a voltage drop (V+−V−) across six heating rods 202. Heating rods 202 connected in series may operate at a lower voltage across each heating rod 202 compared to heating rods connected in parallel.

In some examples, heating assemblies may include heating rods connected in parallel. FIG. 2B is a side view diagram illustrating an example parallel configuration of heating rods in a heating assembly. Heating assembly 210 includes two or more heating rods 212 connected in parallel and coupled to a current source by an inlet connective bus bar 214A and an outlet connective bus bar 214B. Heating assembly 210 may operate at a voltage drop (V+−V−) across one heating rod 212. Heating rods 202 connected in parallel may ensure continuity in the event a heating rods fails and/or enable heating rods 202 having different dimensions to be used.

In some examples, heating assemblies may include heating rods connected in both series and parallel. FIG. 2C is a side view diagram illustrating an example mixed configuration of heating rods in a heating assembly. Heating assembly 220 includes a first set of heating rods 222A and a second set of heating rods 222B, in which heating rods within each set of heating rods 222A, 222B are connected in series by connective bus bars 224. End heating rods of each set of heating rods 222 are coupled at one end to a current source at an inlet end bus bar 226A and at another end an outlet end bus bar 226B, such that the first set of heating rods 222A and the second set of heating rods 222B are connected in parallel. Heating assembly 220 may operate at a voltage drop (V+−V−) across three heating rods 222.

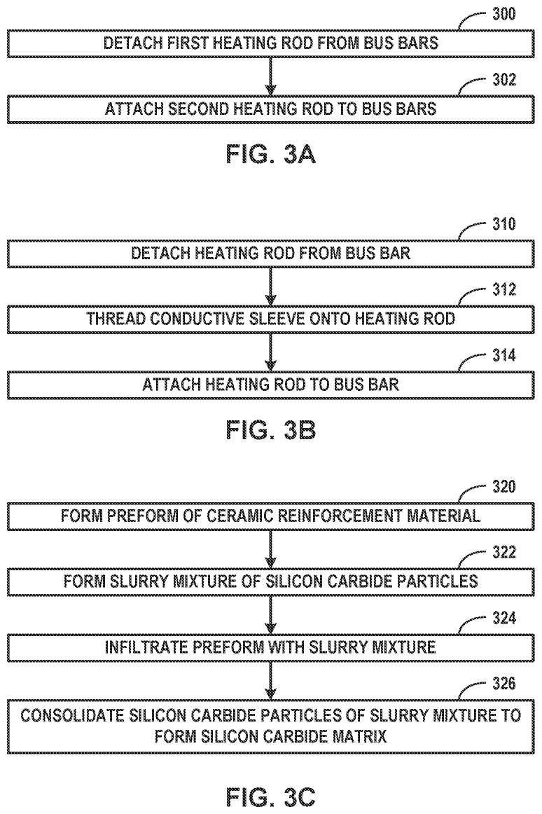

Heating assemblies described herein may include heating rods that are relatively easy to replace compared to heating assemblies that include heating rods in a set configuration. FIG. 3A is a flowchart of an example technique for repairing a heating assembly by replacing a heating rod of the heating assembly, and will be described with respect to heating rod 128 of FIG. 1C and inter-rod bus bar 130A of FIG. 1E. The technique of FIG. 3A includes detaching a first heating rod 128 from two or more bus bars 130 (300). For example, a first end 144A of the first heating rod 128 may be detached from a first bus bar 130A and a second, opposite end 144B of the first heating rod 128 may be detached from a second bus bar 130A, such as by rotating rod nuts 162 of each inter-rod bus bar 130A in a first direction. The technique of FIG. 3A includes attaching a second heating rod 128 to the two or more bus bars 130 (302). For example, a first end 144A of the second heating rod 128 may be attached to the first bus bar 130A and a second, opposite end 144B of the second heating rod 128 may be attached to the second bus bar 130A, such as by rotating rod nuts 162 of each inter-rod bus bar 130A in a second, opposite direction.

Heating assemblies described herein may include heating rods that are relatively easy to repair compared to heating assemblies that include heating rods devoid of connective structures. FIG. 3B is a flowchart of an example technique for repairing a heating assembly by repairing a heating rod of the heating assembly, and will be described with respect to heating rod 128 of FIG. 1C and conductive sleeve 150 of FIG. 1D. The technique of FIG. 3B includes detaching a heating rod 128 from two or more bus bars 130 (310), such as described in step 302 of FIG. 3A. The technique of FIG. 3B includes threading conductive sleeve 150 onto heating rod 128 to bridge a flow of electrical energy across a discontinuity (312). The discontinuity may include, for example, a deviation in microstructure of heating rod 128 that reduces an electrical conductivity of heating rod 128, such as a partial or full through-crack. The technique of FIG. 3B includes attaching heating rod 128 to bus bar 130 (314).

Heating rods of heating assemblies described herein may be formed by any of a variety of methods including, but not limited to, slurry infiltration, chemical vapor deposition, physical vapor deposition, or any method that forms a rod of a composite having a ceramic reinforcement material and a silicon carbide matrix. In some examples, heating rods may be formed using slurry infiltration to further tailor an electrical conductivity of the silicon carbide matrix of the heating rod. FIG. 3C is a flowchart of an example technique for forming a heating rod of a heating assembly using slurry infiltration, and will be described with respect to heating rod 128 of FIG. 1C.

The technique of FIG. 3C includes forming a preform of a ceramic reinforcement material (320). The preform may have a shape similar to a final shape of heating rod 128. The technique of FIG. 3C includes forming a slurry mixture that includes a solvent and silicon carbide particles (322). In some examples, the slurry mixture further includes one or more conductive materials configured to increase the electrical conductivity of the composite of the resulting heating rod 128. For example, the slurry mixture may have a concentration of conductive fillers such that the electrical conductivity of the composite is greater than silicon carbide, yet lower than other materials used in heating elements, such as silicon nitride or metals.

The technique of FIG. 3C includes infiltrating the preform of the ceramic reinforcing material with the slurry mixture (324). The slurry mixture may flow into a volume between fibers of the ceramic reinforcement material. The technique of FIG. 3C includes consolidating the silicon carbide particles to form a composite that includes a silicon carbide matrix (326). For example, the infiltrated preform may be heated to remove the solvent and soften the silicon carbide particles to form a solid silicon carbide matrix.

The following numbered examples may demonstrate one or more aspects of the disclosure.

Example 1: A heating assembly includes one or more heating rods, wherein each heating rod of the one or more heating rods defines a first end and a second end, and comprises a composite that includes a silicon carbide (SiC) matrix; a first bus bar coupled to the first end of at least one heating rod; and a second bus bar coupled to the second end of the at least one heating rod.

Example 2: The heating assembly of example 1, wherein the composite has an electrical conductivity less than about 105 siemens per meter (S/m).

Example 3: The heating assembly of any of examples 1 and 2, wherein the composite comprises one or more conductive fillers configured to increase an electrical conductivity of the composite.

Example 4: The heating assembly of any of examples 1 through 3, wherein each of the first and second bus bars comprises a material having an electrical conductivity greater than about 106 siemens per meter (S/m).

Example 5: The heating assembly of any of examples 1 through 4, wherein each of the one or more heating rods is threaded.

Example 6: The heating assembly of any of examples 3 through 5, further comprising one or more conductive sleeves configured to thread onto the one or more heating rods and bridge a flow of electrical energy across a discontinuity in at least one heating rod.

Example 7: The heating assembly of example 6, wherein each of the one or more conductive sleeves comprises a material having an electrical conductivity greater than about 106 siemens per meter (S/m).

Example 8: The heating assembly of any of examples 1 through 7, wherein each heating rod of the one or more heating rods comprises a SiC/SiC ceramic composite, and wherein each of the first and second bus bars comprises graphite.

Example 9: A heating assembly package includes one or more heating rods comprising a composite that includes a silicon carbide (SiC) matrix; and a set of bus bars configured to electrically couple the one or more heating rods to a power circuit to deliver electrical energy to the one or more heating rods.

Example 10: The heating assembly package of example 9, wherein the one or more heating rods comprise two or more heating rods, and wherein the set of bus bars is configured to electrically couple at least two heating rods of the two or more heating rods in series.

Example 11: The heating assembly package of any of examples 9 and 10, wherein the one or more heating rods comprise two or more heating rods, and wherein the set of bus bars is configured to electrically couple at least two heating rods of the two or more heating rods in parallel.

Example 12: The heating assembly package of any of examples 9 through 11, wherein the set of bus bars comprises two or more end bus bars each configured to electrically couple at least one heating rod of the one or more heating rods to the power circuit.

Example 13: The heating assembly package of example 12, wherein the one or more heating rods comprise two or more heating rods, and wherein the set of bus bars further comprises one or more inter-rod bus bars each configured to couple to an end of a first heating rod of the two or more heating rods and an end of a second heating rod of the two or more heating rods.

Example 14: The heating assembly package of any of examples 9 through 13, wherein the one or more heating rods comprises two or more heating rods, and wherein the set of bus bars comprises one or more end inter-rod bus bars each configured to electrically couple at least two heating rods of the two or more heating rods to the power circuit.

Example 15: The heating assembly package of any of examples 9 through 14, wherein each heating rod of the one or more heating rods is threaded.

Example 16: The heating assembly package of example 15, wherein each bus bar of the set of bus bars is configured to thread onto at least one heating rod of the one or more heating rods.

Example 17: The heating assembly package of any of examples 15 and 16, further comprising one or more conductive sleeves configured to thread onto at least one heating rod of the one or more heating rods and bridge a flow of electrical energy across a discontinuity in the at least one heating rod.

Example 18: A thermal process system includes a vessel configured to house one or more process gases; and a heating assembly configured to heat the vessel, wherein the heating assembly comprises: one or more heating rods, wherein each heating rod of the one or more heating rods defines a first end and a second end, and comprises a composite that includes a silicon carbide (SiC) matrix; a first bus bar coupled to the first end of at least one heating rod; and a second bus bar coupled to the second end of the at least one heating rod.

Example 19: The thermal process system of example 18, wherein each of the one or more heating rods is threaded.

Example 20: The thermal process system of any of examples 18 and 19, wherein the thermal process system includes a methane pyrolysis reactor.

Example 21: A method for repairing a heating assembly includes detaching a first end of a first heating rod from a first bus bar and a second end of the first heating rod from a second bus bar; and attaching a first end of a second heating rod to the first bus bar and a second end of the second heating rod to the second bus bar, wherein each of the first and second heating rods comprises a composite that includes a silicon carbide (SiC) matrix.

Example 22: A method for repairing a heating rod of a heating assembly includes detaching a first end of the heating rod from a bus bar, wherein the heating rod comprises a composite that includes a silicon carbide (SiC) matrix, wherein the heating rod is threaded, and wherein the heating rod includes a discontinuity that reduces an electrical conductivity of the heating rod; threading a conductive sleeve onto the heating rod to bridge a flow of electrical energy across the discontinuity; and attaching the first end of the heating rod to the bus bar.

Example 23: A method for fabricating a heating rod includes infiltrating a preform of a ceramic reinforcing material with a slurry that includes silicon carbide particles; and consolidating the silicon carbide particles to form a composite that includes a silicon carbide matrix.

Example 24: The method of example 23, wherein the slurry comprises one or more conductive fillers configured to increase an electrical conductivity of the composite.

Example 25: A method for heating a thermal process system includes controlling electrical energy provided to a heating assembly of the thermal process system to heat one or more process gases in a vessel of the thermal process system, wherein the heating assembly comprises: one or more heating rods defining a first end and a second end, wherein each heating rod comprises a composite that includes a silicon carbide (SiC) matrix; a first bus bar coupled to the first end of at least one heating rod; and a second bus bar coupled to the second end of the at least one heating rod.

Various examples have been described. These and other examples are within the scope of the following claims.

What is claimed is:

1. A heating assembly, comprising:
one or more heating rods, wherein each heating rod of the one or more heating rods defines a first end and a second end, and comprises a composite that includes a silicon carbide (SiC) matrix;
a first bus bar coupled to the first end of at least one heating rod; and
a second bus bar coupled to the second end of the at least one heating rod.

2. The heating assembly of claim 1, wherein the composite comprises one or more conductive fillers configured to increase an electrical conductivity of the composite.

3. The heating assembly of claim 1, wherein each of the one or more heating rods is threaded.

4. The heating assembly of claim 3, further comprising one or more conductive sleeves configured to thread onto the one or more heating rods and bridge a flow of electrical energy across a discontinuity in at least one heating rod.

5. The heating assembly of claim 4, wherein each of the one or more conductive sleeves comprises a material having an electrical conductivity greater than about 10⁶ siemens per meter (S/m).

6. The heating assembly of claim 1,
wherein each heating rod of the one or more heating rods comprises a SiC/SiC ceramic composite, and
wherein each of the first and second bus bars comprises graphite.

7. The heating assembly of claim 1, wherein the composite has an electrical conductivity less than about 10⁶ siemens per meter (S/m).

8. The heating assembly of claim 1, wherein each of the first and second bus bars comprises a material having an electrical conductivity at least ten times greater than an electrical conductivity of the composite.

9. A heating assembly package, comprising:
one or more heating rods comprising a composite that includes a silicon carbide (SiC) matrix; and
a set of bus bars configured to electrically couple the one or more heating rods to a power circuit to deliver electrical energy to the one or more heating rods.

10. The heating assembly package of claim 9,
wherein the one or more heating rods comprise two or more heating rods, and
wherein the set of bus bars is configured to electrically couple at least two heating rods of the two or more heating rods in series.

11. The heating assembly package of claim 9,
wherein the one or more heating rods comprise two or more heating rods, and
wherein the set of bus bars is configured to electrically couple at least two heating rods of the two or more heating rods in parallel.

12. The heating assembly package of claim 9, wherein the set of bus bars comprises two or more end bus bars each configured to electrically couple at least one heating rod of the one or more heating rods to the power circuit.

13. The heating assembly package of claim 12,
wherein the one or more heating rods comprise two or more heating rods, and
wherein the set of bus bars further comprises one or more inter-rod bus bars each configured to couple to an end of a first heating rod of the two or more heating rods and an end of a second heating rod of the two or more heating rods.

14. The heating assembly package of claim 9,
wherein the one or more heating rods comprises two or more heating rods, and
wherein the set of bus bars comprises one or more end inter-rod bus bars each configured to electrically couple at least two heating rods of the two or more heating rods to the power circuit.

15. The heating assembly package of claim 9, wherein each heating rod of the one or more heating rods is threaded.

16. The heating assembly package of claim 15, wherein each bus bar of the set of bus bars is configured to thread onto at least one heating rod of the one or more heating rods.

17. The heating assembly package of claim 15, further comprising one or more conductive sleeves configured to thread onto at least one heating rod of the one or more heating rods and bridge a flow of electrical energy across a discontinuity in the at least one heating rod.

18. A thermal process system, comprising:
a vessel configured to house one or more process gases; and
a heating assembly configured to heat the vessel, wherein the heating assembly comprises:
one or more heating rods, wherein each heating rod of the one or more heating rods defines a first end and a second end, and comprises a composite that includes a silicon carbide (SiC) matrix;
a first bus bar coupled to the first end of at least one heating rod; and
a second bus bar coupled to the second end of the at least one heating rod.

19. The thermal process system of claim 18, wherein each of the one or more heating rods is threaded.

20. The thermal process system of claim 18, wherein the thermal process system includes a methane pyrolysis reactor.
